(19) United States
(12) Patent Application Publication
(10) Pub. No.: US 2016/0005285 A1
(43) Pub. Date: Jan. 7, 2016

(54) BABY- AND PET-SAFE VEHICLE PARKING ARRANGEMENT

(71) Applicant: Panasonic Automotive Systems Company of America, Division of Panasonic Corporation of North America, Peachtree City, GA (US)

(72) Inventor: RENU BALAKRISHNA, Sunnyvale, CA (US)

(21) Appl. No.: 14/793,509

(22) Filed: Jul. 7, 2015

Related U.S. Application Data
(60) Provisional application No. 62/021,394, filed on Jul. 7, 2014.

(51) Int. Cl. G08B 21/02; E05B 77/54; B60R 25/102; B60R 25/31; G07C 9/00; B60R 25/01

(52) U.S. Cl. CPC G08B 21/02; G07C 9/00007; B60R 25/01; B60R 25/102; B60R 25/31; E05B 77/54; E05B 2047/0067

(57) ABSTRACT

An emergency broadcast arrangement for a vehicle includes a sensor detecting a presence of a human or pet in the vehicle. A radio frequency transmitter is disposed in the vehicle and transmits an RF signal in response to the detection of the presence of a human or pet in the vehicle. A remote key fob is associated with the vehicle and receives the RF signal.

### CROSS-REFERENCE TO RELATED APPLICATIONS

This application claims the benefit of U.S. Provisional Application No. 62/021,394 filed on Jul. 7, 2014, the disclosure of which is hereby incorporated by reference in its entirety for all purposes.

### BACKGROUND OF THE INVENTION

1. Field of the Invention

The present invention relates to a method of enhancing the safety of humans and animals within a parked vehicle.

2. Description of the Related Art

There are increasing incidents of a baby/pet locked inside a vehicle and subjected to dangerous temperature/climate conditions. The dangerous conditions are not detected and communicated to anyone to rectify the situation. Various schemes have been proposed for improving the safety of inhabitants of a parked vehicle. However, none have had the necessary sophistication to be workable and practical enough to be actually implemented in vehicles.

### SUMMARY OF THE INVENTION

The invention may provide an in-car system that protects lives when the car is parked. The car may be able to communicate to its owner about any emergency situation while in park. The car may be enabled to gain attention from the nearest people in case of an emergency, if there is no communication/assistance from the holder of the car key fob. The invention may increase the probability of any person/pet in the car receiving immediate assistance in an emergency situation.

The invention may provide a baby- and pet-safe parking arrangement for vehicles. Particularly, the invention may provide a method of smart locking for vehicles which improves the safety of infants and animals who may be in the vehicle while the vehicle is parked. More particularly, the invention may provide an automatic climate safety feature wherein the vehicle climate control system is automatically operated while the vehicle is parked in order to avoid dangerous temperatures within the passenger compartment. The invention may also provide a car remote alert feature wherein the parked vehicle automatically transmits an alarm signal to a remote receiver in response to determining the possibility of dangerous climate conditions within the vehicle. The invention may also provide a parked emergency broadcast feature in which the vehicle, in response to determining the possibility of dangerous climate conditions within the vehicle, emits signals that are visible and/or audible within the vicinity of the vehicle so that nearby human observers may be alerted to intervene in a dangerous situation.

The invention may provide a security feature that monitors the climate conditions (e.g., temperature, humidity, air pressure, etc.) inside the car for safety in all the states of a car if there is a human or pet in the car. Thus, unsafe car conditions in the car while the car is parked may be avoided. The presence of the human or pet within the car may be determined by any known method, including, but not limited to motion sensing and carbon dioxide sensing.

The inventive system may protect the life of the human/pet inside the vehicle in the event that the driver/car key holder ignores a first warning and decides to lock the car with the human/pet inside the car. The inventive system may provide advanced security features in a warning system that improve the life security of the person inside the parked car in addition to warning the person possessing the car key fob.

The invention may provide an emergency communication system which communicates with the car remote key fob, broadcasts an audible or radio frequency signal about the emergency, or triggers an alarm to make sure that attention is drawn to the emergency as soon as possible. The key fob may have improved communication with the parked car as compared to conventional schemes.

The broadcast parking emergency communication from the vehicle is a novel feature along with the “repeated broadcast” feature in which a smart key fob or any receiver can effectively increase the communication distance of an emergency message originally transmitted from another car by repeating or relaying the transmission.

Broadcast receiving stations may be included in parking lot managing systems in a shopping mall or office park, for example. These receiving stations can receive emergency messages so that such emergency messages may be attended to as soon as possible.

The invention may enable emergency mobile communication from a car to emergency contacts.

An additional indication of a pet/human being inside a car may be provided, such as a small LED. This indicator can be always ON if there is a human/pet inside the parked car, or ON only after a time limit and/or climate change limit with a human/pet inside the parked car. This indicator may facilitate an outside observer in identifying the vehicle that has an emergency, which the observer may have heard about on an emergency message broadcast.

The invention comprises, in one form thereof, an emergency broadcast arrangement for a vehicle, including a sensor detecting a presence of a human or pet in the vehicle. A radio frequency transmitter is disposed in the vehicle and transmits an RF signal in response to the detection of the presence of a human or pet in the vehicle. A remote key fob is associated with the vehicle and receives the RF signal.

The invention comprises, in another form thereof, an emergency broadcast arrangement for a vehicle, including a sensor detecting a presence of a human or pet in the vehicle. An alarm emits a radio frequency alarm signal to a key fob associated with the vehicle in response to the detection of the presence of a human or pet in the vehicle.

The invention comprises, in yet another form thereof, a vehicular emergency broadcast arrangement including a sensor detecting a presence of a human or pet in a first vehicle. A first key fob is associated with the first vehicle. A transmitter is disposed in the first vehicle and transmits an air-borne signal in response to the detection of the presence of a human or pet in the first vehicle. A second key fob is associated with a second vehicle. The second key fob receives the air-borne signal and re-transmits the air-borne signal to the first key fob.

An advantage of the present invention is that it may protect not only an infant in a car seat, but any human or pet, and in any seat or position within the vehicle.

Another advantage of the invention is that it may protect any human or pet in the event that the car key fob holder leaves a pet/human inside the car and also forgets to lock the car.

Yet another advantage of the invention is that it may make the car “more intelligent” where in unavoidable situations the in-car system can take measures to avoid an unsafe condition for a pet/human inside the car.

### BRIEF DESCRIPTION OF THE DRAWINGS

The above-mentioned and other features and objects of this invention, and the manner of attaining them, will become more apparent and the invention itself will be better understood by reference to the following description of embodiments of the invention taken in conjunction with the accompanying drawings, wherein:

FIG. 1 is a diagram of one embodiment of a parking arrangement of the present invention with a monitoring system ON when there is a human/pet detected inside the vehicle.

FIG. 2 is a diagram of another embodiment of a parking arrangement of the present invention with a warning signal transmitted to a remote key fob.

FIG. 3 is a diagram of yet another embodiment of a parking arrangement of the present invention with an emergency broadcast being transmitted.

FIG. 4 is a block diagram of one embodiment of a vehicular emergency broadcast arrangement of the present invention.

### DETAILED DESCRIPTION

### Glossary

key fob—a palm-sized portable device capable of controlling various parts of a car.
climate control system—an apparatus capable of heating and/or cooling the passenger compartment of a vehicle.

The embodiments hereinafter disclosed are not intended to be exhaustive or limit the invention to the precise forms disclosed in the following description. Rather the embodiments are chosen and described so that others skilled in the art may utilize its teachings.

The present invention may include an automatic climate safety feature providing permission to, and enabling, the in-car system to take necessary actions to regain safe climate conditions inside the car if determined to be called for. This automatic climate safety feature can be turned ON or OFF by direct interaction with the in-car system or by using a smart remote control of the car. This feature may be turned ON by the car user at any time. However, turning OFF the feature can be limited to only being performed while the car is not in park in order to avoid the car key holder accidentally turning off the feature. This limitation on turning OFF the feature can be varied as per the specific car model design requirements. If the feature is turned ON before locking or parking the car then there may be no need for confirmation of the feature being turned ON after the car is locked or parked.

In another embodiment, if there is determined to be a human or pet in the car and the user makes an attempt to lock the car from the outside, then there is an additional short audible and/or visible warning alarm from the car and/or from the remote key fob, or from another type of remote controller. An additional confirmation of lock may be required from the remote key fob in order to lock the car with a human and/or pet inside. Receipt of the additional confirmation of lock from the remote key fob may turn ON a special monitoring mode in the car. The automatic climate safety feature may also be turned ON at this point with or without the key holder's permission as per the security guarantee level required by the system. The automatic climate safety feature may start the automatic climate control inside the car in order to keep the climate levels inside the vehicle within a preferred range of climate levels.

In one embodiment, if the person holding the remote key forgets to lock the car then the monitoring system is automatically ON. Thus, the security feature may work even when the user leaves a pet or baby in the car and forgets to lock the car.

When the monitoring mode is ON and if the climate conditions inside the car drift towards the unsafe range of conditions, which may be settable by the user, then there may be an alert signal transmitted from the car to the remote key fob. If the automatic climate safety feature is ON, then the in car security system may automatically begin an attempt to regain the safe climate conditions in the passenger compartment of the car. This attempt may include turning on the engine, turning on the air conditioning, turning on the heat, turning on the fan, and/or opening the windows of the vehicle.

When the remote key fob receives the above mentioned alert signal, the person holding the remote key fob can turn ON the automatic climate safety feature. For example, the user may turn ON an emergency climate regain procedure which may regain the safe climate conditions inside the car by turning on the engine, turning on the air conditioning, turning on the heat, turning on the fan, and/or opening the windows of the vehicle.

If the above alert signal communication is missed or ignored by the person holding the car remote key fob and the climate level within the passenger compartment reaches critical levels, which may be settable by the user, then the vehicle may transmit a wireless emergency warning signal to the remote key fob controller again. The vehicle may also transmit a parked emergency broadcast message signal which the parking lot management system can receive. The signal may identify the vehicle and request that parking lot personnel give the vehicle immediate attention. The vehicle may also emit an audible alarm in order to attract immediate attention. If the automatic climate safety feature is ON, then the climate control system in the car may be automatically started if it is not already ON. After a particular critical threshold of climate conditions has been exceeded, the automatic climate safety feature may turn ON automatically no matter what settings have been entered by the human holder of the car key. The parked vehicle may also transmit an emergency broadcast message which can be received by the parking lot management system or by any system designed to receive the broadcast message. This message may contain information necessary for vehicle identification and for notifying the recipient that the car needs immediate attention. This broadcast transmission can be repeated by any transceiver that is able to receive such signals in order to increase the communication range of the vehicle.

Emergency actions may be taken if the pet or human is inside and the automatic climate safety feature is ON for a long time, which has the potential to drain the battery drain and cause the system to fail. If a pet or human is locked inside the car for more than a particular time limit, then the communication may be started with the remote key fob and/or by emitting a parked emergency broadcast message signal and/or the car alarm signal. For additional safety, it is possible for the system to have a secondary power source backup.

If the system is unable to get any response from the remote key fob to any of the above communications to the remote key fob, or if the car battery levels are too critically low to continue the automatic climate safety feature, or at any other time when determined necessary, the in-car security system may automatically lower the wind shields or windows if such lowering is determined to be needed, based on outside climate levels and/or risk analysis, in order to avoid danger to the pet or human. This feature can be preset if needed.

The system may be turned off if the human or pet in the car exits the car. The feature may also be manually canceled by a person inside the car in the case of less critical climate levels. The cancelation may need to be confirmed before the cancelation takes effect. The confirmation of the cancelation may be required to occur at least a short time interval after the initial cancellation in order to avoid accidental cancelation. The length of the time interval may depend on the criticality assessment by the master controller.

There may be a small indicator on the parked car such as a small low power LED to indicate that there is a pet/human inside the parked car. The indicator may be powered from an alternate or backup power source. This indicator may increase the chances that a bystander near the parked car will notice any hazardous situations inside the car.

Automatic climate safety can be kept ON by default for high accuracy systems and for additional safety.

Major components of the inventive system include the master controller unit, the smart remote key fob, and the sensors for human or pet detection. The master controller unit may be included in the car navigation system or may be a low power single purpose controlling unit that is powered by an alternative backup power source which is in active mode if the presence of a human or pet in the car is detected. The master controller unit may act as the master in the system, may communicate with other electronic control units (ECUs) in the car, and may initiate and/or receive communication from the car remote key fob. The master controller unit may be a power-optimized controller which consumes minimum power during low power states of the car and thereby reduces the battery power consumption.

The master controller unit may perform the following major functions:
a) Safe condition settings, which can be set by the user within limits:
Settings 1—These settings may set the limit criteria to define the drift from safe climate conditions. If the climate conditions reach the level of these limit criteria, then it may be determined that the climate conditions may likely soon shift to critically unsafe levels.
Settings 2—This setting may set the critical climate level limits. If the condition inside the car reaches this level then it may be considered to be unsafe.
The master controller may ensure that these two settings are within some limits even in the default case in which the settings have never been set or adjusted by the user.
Preferred Settings—This is the target setting for the automatic climate safety feature. The target setting may be a valid safe value in all cases.
b) Controlling the ON/OFF state of the automatic climate safety feature. The user may set the ON/OFF state within the car or via a remote controller.
c) If there is a human/pet detected in the vehicle and the car is locked from the outside, then a warning message may be sent to the remote controller asking for confirmation.
d) If it is confirmed that the car is to be locked with the pet/human in the car, such as via a communication back from the remote controller, then the monitoring system may be kept in the active mode. If the car is parked and has not been locked for a particular time duration, then the monitoring system may be automatically activated.
e) If the automatic climate safety feature is turned ON, then the climate inside the car may be automatically adjusted to keep the car in preferred settings while parked.
f) If the car is still parked after a maximum time limit, or there is a shift in climate conditions beyond Settings 2 (denoting an unsafe condition) with a human/pet inside the car, then an alarm signal may be transmitted to the smart key fob, the car alarm may be started, and/or a parked emergency broadcast message may be transmitted.
g) Make major decisions.

The inventive smart key fob may be able to communicate with the car in order to warn/alarm the owner of an emergency situation inside a locked car. The emergency situation may be in the form of a human/pet being detected inside a locked car coupled with the climate conditions (e.g., temperature, humidity, air pressure etc.) inside the car being unsuitable for a human or a pet.

The smart key fob may have the following features:
a) A small display/button/alarm may facilitate communication of the alerts and other emergency signals between the car and the key fob.
b) The ability to repeat an emergency broadcast received from any other car, thereby increasing the broadcast range of the emergency broadcast, i.e., the distance over which the emergency broadcast may be communicated.
c) An emergency climate control ON/OFF button. In the ON position, the master controller has permission to take necessary emergency actions to regain the safe conditions in the car. In the OFF position, it may not. For example, in the ON position the key fob may transmit or not transmit a signal indicating permission to operate the climate control system. In the OFF position as well, the key fob may transmit or not transmit a signal indicating denial of permission to operate the climate control system.

Sensors for detection of a human/pet inside the car may be able to communicate accurately with the master controller regarding the presence of the human/pet in the car. Movement sensors, motion sensors, sound detectors, microphones, and body heat sensors may be used in combination to improve the accuracy of presence detection and to avoid false negative presence detection. Temperature and other climate conditional sensors inside the car provide for current climate condition measurement.

In one embodiment, an emergency mobile communication feature is added to existing in-car systems. An in-car navigation/GPS system may be able to make emergency calls by itself without a bonded or separate phone. That is, the navigation system may include in-built telephone features which provide at the least the ability to make emergency calls.

The navigation system may also include a subscriber identity module (SIM) card slot and additional features for the same. The navigation system may be able to communicate using the integrated internal phone in case of emergency. For example, the phone may be able to initiate automatic calling to some emergency contacts in the system. If the system detects the need to make a call, such as due to an emergency, then the system can initiate an emergency call to the nearest emergency service based on the GPS location/country emergency handling guidelines.

There can be a list of emergency contacts maintained in the system who may be immediately contacted via an electronic message when a pet/human is locked in the car. Warning messages/calls can be sent with automated messages when the system detects critical limits. This has the advantage of enabling communication about emergencies over long distances.

In one embodiment, the managing system of the parking lot/garages can have the ability to receive basic parking emergency broadcasts.

In another embodiment, the emergency broadcast/communication to the key fob feature is applied to other kinds of emergencies and to vehicle tracking.

Systems which are able to receive the emergency broadcast message can also be designed as, and/or utilized as, repeaters. For example, a smart key fob or a vehicle can be designed to receive any emergency parking broadcast message and retransmit the message if the message is not addressed to, or does not correspond to, the vehicle itself. This may increase the effective communication range and may increase the success rate of the car key holder getting the emergency message even from longer ranges of distance.

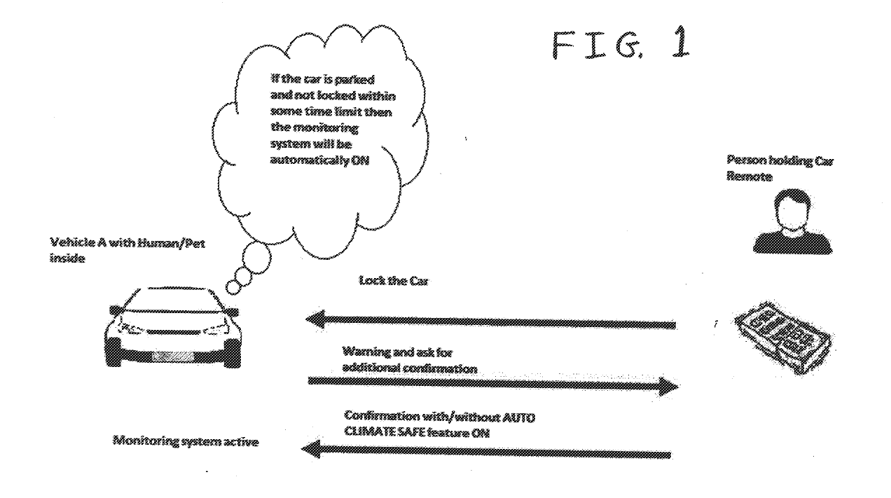

FIG. 1 is a diagram of one embodiment of a parking arrangement of the present invention with a monitoring system ON when there is a human/pet detected inside the vehicle by a sensor. The monitoring system may be active. The vehicle has a human or pet inside. If the car is parked and not locked within some time limit, then the monitoring system may automatically turn ON. The person hold the car remote key fob may transmit a signal to the car to lock the car. In response, the car may transmit a signal to the key fob warning that a human or pet is in the car, and asking for additional confirmation to lock the car. The user may use the key fob to transmit a confirmation signal back to the car with or without the AUTO CLIMATE SAFE feature turned ON.

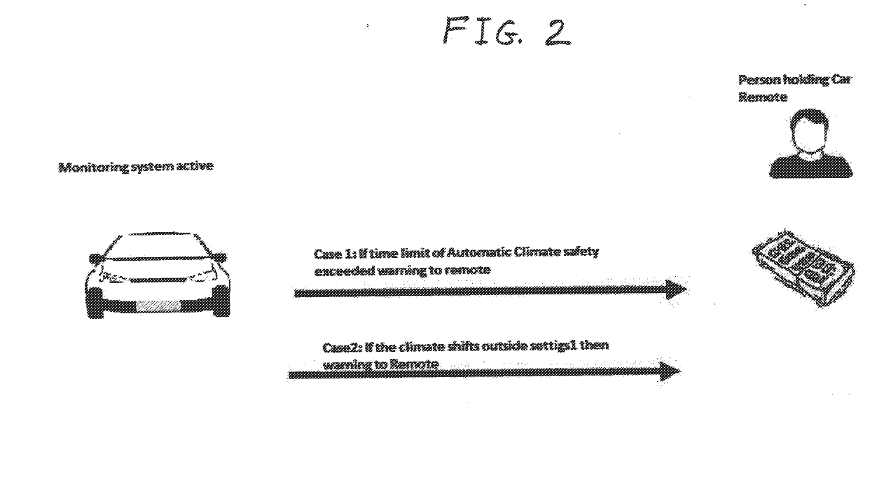

FIG. 2 is a diagram of another embodiment of a parking arrangement of the present invention with a warning signal transmitted to a remote key fob. The monitoring system may be active. If a time limit of the automatic climate safety is exceeded, then a warning signal is transmitted to the key fob being held by a user. Else, if the climate shifts outside settings 1, then a warning signal is transmitted to the key fob being held by a user.

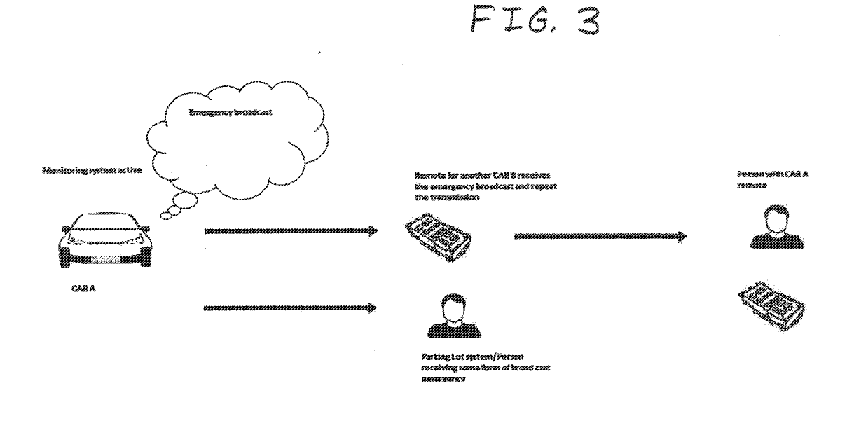

FIG. 3 is a diagram of yet another embodiment of a parking arrangement of the present invention with a emergency broadcast being transmitted from car A and the monitoring system being active. The remote key fob of another car (car B) may receive the emergency broadcast and repeat the transmission of the emergency broadcast. The person with the remote key fob belonging to car A may then receive the re-transmitted emergency broadcast. In addition, a parking lot system or a person may receive the broadcast emergency signal.

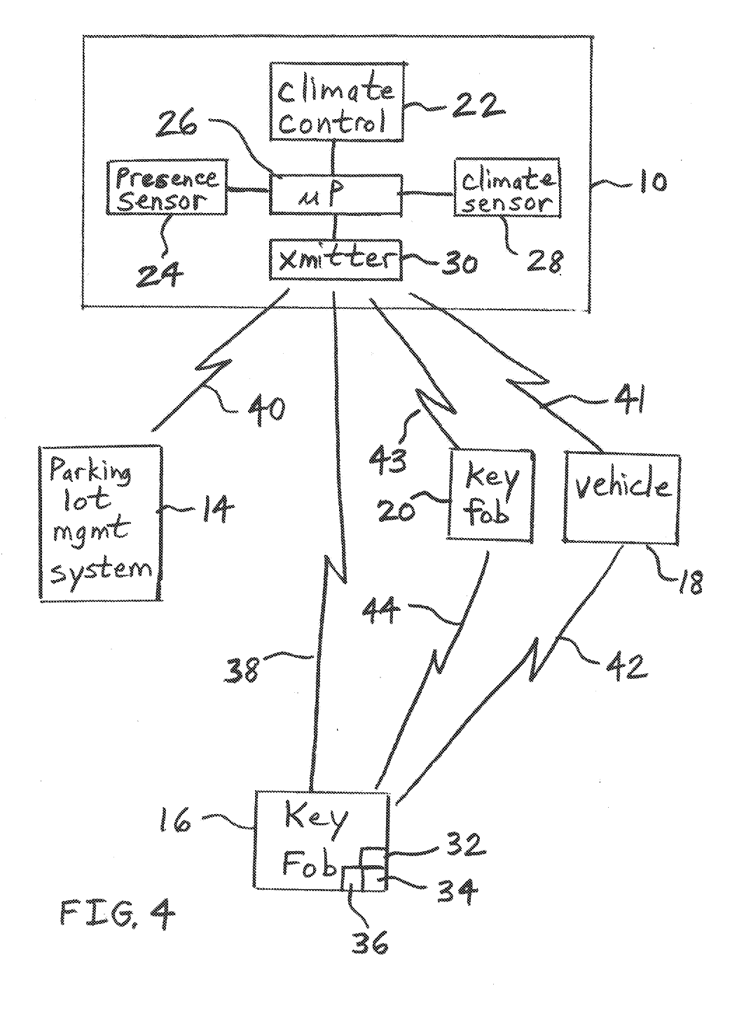

FIG. 4 illustrates a vehicular emergency broadcast arrangement 10 of the present invention, including a vehicle 12, a parking lot management system 14, a key fob 16, an other vehicle 18, and an other key fob 20. Vehicle 10 includes a climate control system 22, a human and pet sensor 24, a processor 26, a climate sensor 28, and a radio frequency transmitter 30. Key fob 16 includes a light emitting element (e.g., a light emitting diode) 32, an audio speaker 34, and a vibrating element 36.

During use, upon presence sensor 24 detecting a human or pet in vehicle 10, and climate sensor 28 detecting unsafe climate conditions in vehicle 10, an alarm including processor 26 and transmitter 30 transmits a radio frequency alarm signal to key fob 16, as indicated at 38, and/or to parking lot management system 14, as indicated at 40. The RF signal may also be received by another vehicle 18 or key fob 20 within transmission range of vehicle 10, as indicated at 41 and 43, respectively. Vehicle 18 or key fob 20 may retransmit the RF signal to key fob 16, as indicated at 42 and 44, respectively.

In response to key fob 16 receiving the alarm signal, light emitting element 32, audio speaker 34, and vibrating element 36 may be activated. Climate control system 22 may also be activated to cool or heat the passenger compartment of vehicle 10 when the alarm signal is transmitted.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. An emergency broadcast arrangement for a vehicle, comprising:
a sensor configured to detect a presence of a human or pet in the vehicle;
a radio frequency transmitter disposed in the vehicle and configured to transmit an RF signal in response to the detection of the presence of a human or pet in the vehicle; and
a remote key fob configured to receive the RF signal.

2. The arrangement of claim 1, wherein the sensor comprises a first sensor, the arrangement further comprising:
a second sensor configured to monitor environmental conditions within the vehicle; and
a climate control system configured to heat or cool a passenger compartment of the vehicle in response to signals from both the first sensor and the second sensor.

3. The arrangement of claim 2, wherein the key fob includes an emergency climate control ON/OFF button having an ON position and an OFF position, wherein in the ON position the key fob indicates permission to operate the climate control system, and in the OFF position the key fob indicates denial of permission to operate the climate control system.

4. The arrangement of claim 3, wherein the key fob indicates denial of permission to operate the climate control system by transmitting a denial signal to the vehicle, and the key fob indicates permission to operate the climate control system by not transmitting the denial signal.

5. The arrangement of claim 1, wherein the key fob is associated with the vehicle.

6. The arrangement of claim 1, wherein the key fob is configured to, in response to receiving the RF signal and a command from a user to lock a door of the vehicle, require a confirmation from the user that he wants the door locked before the key fob causes the door of the vehicle to be locked.

7. The arrangement of claim 1, wherein the key fob is configured to, in response to receiving the RF signal and a command from a user to lock a door of the vehicle, emit and audible warning and/or a visible warning to the user, and not emit the warning if the RF signal has not been received by the key fob.

8. The arrangement of claim 1, further comprising a light emitting diode configured to emit light whenever the presence of a human or pet in the vehicle is detected.

9. The arrangement of claim 1, further comprising a wireless phone system disposed within the vehicle configured to place a telephone call to an emergency contact telephone number in response to the detection of the presence of a human or pet in the vehicle.

10. An emergency broadcast arrangement for a vehicle, comprising:
a sensor configured to detect a presence of a human or pet in the vehicle; and
an alarm configured to emit a radio frequency alarm signal to a key fob in response to the detection of the presence of a human or pet in the vehicle.

11. The arrangement of claim 10, wherein the key fob includes a light emitting element configured to emit light, a speaker configured to emit an audible sound, or a vibrating element configured to vibrate in response to receiving the alarm signal.

12. The arrangement of claim 10, wherein the alarm is configured to emit the alarm signal only after the human or pet has been present in the vehicle for a length of time without an engine of the vehicle running.

13. The arrangement of claim 10, wherein the sensor comprises a first sensor, the arrangement further comprising a second sensor configured to monitor environmental conditions within the vehicle, wherein the alarm is configured to emit the alarm signal only after the second sensor has detected that the environmental conditions within the vehicle are within a certain range.

14. The arrangement of claim 10, wherein the key fob is associated with the vehicle, the alarm being configured to emit the radio frequency alarm signal only to the associated key fob.

15. The arrangement of claim 10, further comprising the key fob, the key fob being configured to receive the radio frequency alarm signal and to retransmit the radio frequency alarm signal to an other key fob, the other key fob being associated with the vehicle.

16. The arrangement of claim 10, further an other vehicle configured to receive the radio frequency alarm signal and to retransmit the radio frequency alarm signal to the key fob.

17. A vehicular emergency broadcast arrangement, comprising:
a sensor configured to detect a presence of a human or pet in a first vehicle;
a first key fob associated with the first vehicle;
a transmitter disposed in the first vehicle and configured to transmit an air-borne signal in response to the detection of the presence of a human or pet in the first vehicle; and
a second key fob associated with a second vehicle, the second key fob being configured to receive the air-borne signal and re-transmit the air-borne signal to the first key fob.

18. The arrangement of claim 17, further comprising a climate control system in the vehicle configured to heat or cool the passenger compartment of the vehicle in response to the detection of the presence of a human or pet in the vehicle.

19. The arrangement of claim 17, wherein the transmitter is configured to transmit the air-borne signal in response to the detection of both the presence of a human or pet in the first vehicle and the engine of the vehicle being OFF.

20. The arrangement of claim 17, further comprising a third vehicle configured to receive the radio frequency alarm signal and to retransmit the radio frequency alarm signal to the first key fob.
